(19) United States
(12) Patent Application Publication
(10) Pub. No.: US 2025/0164596 A1
(43) Pub. Date: May 22, 2025

(54) DIRECTION-FINDING AMBIGUITY RESOLUTION IN LONG BASELINE INTERFEROMETERS USING RANDOM FOREST REGRESSION

(71) Applicant: Raytheon Company, Tewksbury, MA (US)

(72) Inventor: Carl A. Nardell, Oro Valley, AZ (US)

(21) Appl. No.: 18/512,900

(22) Filed: Nov. 17, 2023

(51) Int. Cl. G01S 3/48; G01S 3/04

(52) U.S. Cl. CPC G01S 3/48; G01S 3/04

(57) ABSTRACT

An apparatus includes multiple antennas each configured to receive one or more incoming signals. The apparatus also includes at least one processing device configured to receive antenna measurements associated with the one or more incoming signals, where the antenna measurements include phase measurements associated with the one or more incoming signals. The at least one processing device is also configured to process the antenna measurements using multiple decision trees of a random forest regressor, where the decision trees are configured to generate multiple initial predictions of an angle of arrival associated with the one or more incoming signals. In addition, the at least one processing device is configured to combine the initial predictions in order to generate a final prediction of the angle of arrival associated with the one or more incoming signals.

### TECHNICAL FIELD

This disclosure is generally directed to radio frequency (RF) interferometers. More specifically, this disclosure is directed to direction-finding ambiguity resolution in long baseline interferometers using random forest regression.

### BACKGROUND

Interferometers are used in numerous fields to obtain useful information. In some cases, for instance, interferometers may be used to identify the angles of arrival of incoming radio frequency (RF) signals. Among other things, this supports direction finding, meaning the directions of signal sources with respect to a reference position can be determined. This may be useful in various commercial and defense-related applications. For example, an angle of arrival of an incoming signal can be used to identify the direction of an airplane, ground vehicle, naval vessel, or other signal source on the ground, in the air, on the water, or in space from a reference position. This capability can also lend itself to other functions, such as identifying pulse-to-pulse correlations to support pulse deinterleaving or determining to what extent an aircraft or other object's cross-section might be visible to the source of the incoming signals.

### SUMMARY

This disclosure relates to direction-finding ambiguity resolution in long baseline interferometers using random forest regression.

In a first embodiment, an apparatus includes multiple antennas each configured to receive one or more incoming signals. The apparatus also includes at least one processing device configured to receive antenna measurements associated with the one or more incoming signals, where the antenna measurements include phase measurements associated with the one or more incoming signals. The at least one processing device is also configured to process the antenna measurements using multiple decision trees of a random forest regressor, where the decision trees are configured to generate multiple initial predictions of an angle of arrival associated with the one or more incoming signals. In addition, the at least one processing device is configured to combine the initial predictions in order to generate a final prediction of the angle of arrival associated with the one or more incoming signals.

In a second embodiment, a method includes receiving one or more incoming signals at multiple antennas. The method also includes providing antenna measurements associated with the one or more incoming signals to a random forest regressor, where the antenna measurements include phase measurements associated with the one or more incoming signals. The method further includes processing the antenna measurements using multiple decision trees of the random forest regressor, where the decision trees generate multiple initial predictions of an angle of arrival associated with the one or more incoming signals. In addition, the method includes combining the initial predictions in order to generate a final prediction of the angle of arrival associated with the one or more incoming signals.

In a third embodiment, a non-transitory machine-readable medium contains instructions that when executed cause at least one processor to obtain antenna measurements associated with one or more incoming signals received at multiple antennas, where the antenna measurements include phase measurements associated with the one or more incoming signals. The non-transitory machine-readable medium also contains instructions that when executed cause the at least one processor to provide the antenna measurements to a random forest regressor and process the antenna measurements using multiple decision trees of the random forest regressor, where the decision trees are configured to generate multiple initial predictions of an angle of arrival associated with the one or more incoming signals. In addition, the non-transitory machine-readable medium contains instructions that when executed cause the at least one processor to combine the initial predictions in order to generate a final prediction of the angle of arrival associated with the one or more incoming signals.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example long baseline interferometer supporting direction-finding ambiguity resolution using random forest regression according to this disclosure;

FIG. 2 illustrates an example device supporting direction-finding ambiguity resolution in the long baseline interferometer of FIG. 1 according to this disclosure;

FIG. 3 illustrates an example random forest regression processing function for direction-finding ambiguity resolution in the long baseline interferometer of FIG. 1 according to this disclosure;

FIGS. 4 through 6 illustrate an example use case for applying direction-finding ambiguity resolution in a long baseline interferometer according to this disclosure; and

FIG. 7 illustrates an example method for direction-finding ambiguity resolution in a long baseline interferometer using random forest regression according to this disclosure.

### DETAILED DESCRIPTION

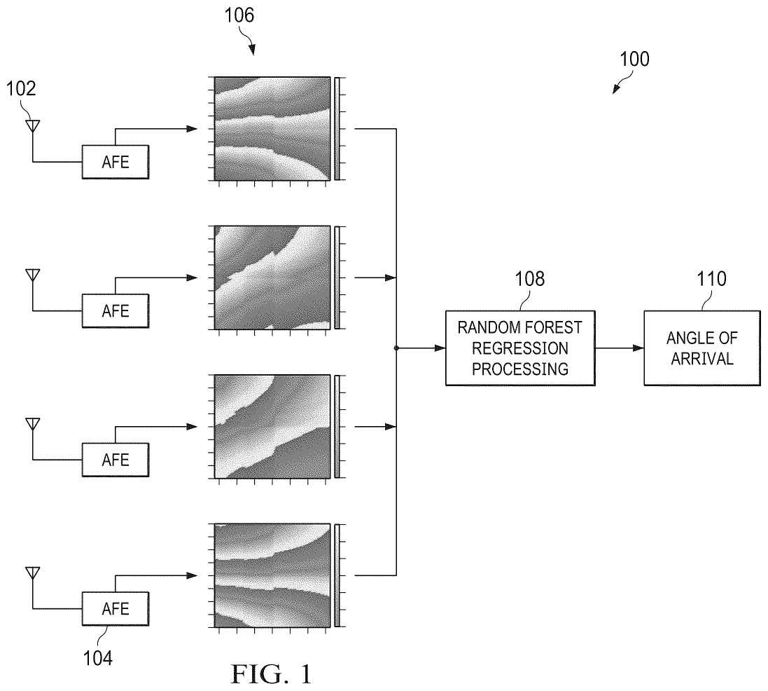

FIGS. 1 through 7, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, interferometers are used in numerous fields to obtain useful information. In some cases, for instance, interferometers may be used to identify the angles of arrival of incoming radio frequency (RF) signals. Among other things, this supports direction finding, meaning the directions of signal sources with respect to a reference position can be determined. This may be useful in various commercial and defense-related applications. For example, an angle of arrival of an incoming signal can be used to identify the direction of an airplane, ground vehicle, naval vessel, or other signal source on the ground, in the air, on the water, or in space from a reference position. This capability can also lend itself to other functions, such as identifying pulse-to-pulse correlations to support pulse deinterleaving or determining to what extent an aircraft or other object's cross-section might be visible to the source of the incoming signals.

One issue that can affect interferometers involves “phase wrapping,” which occurs when antennas of the interferometers are spaced relatively far apart. Phase wrapping occurs when antennas are spaced far enough apart that a signal received at one antenna is more than 360° (2π) out-of-phase with respect to the same signal received at another antenna. This results in phase ambiguity and makes it harder to use the signals received at the different antennas.

Some approaches for dealing with this issue require the use of rigid constraints on both the placement and the spacing of the antennas in an interferometer. Also, while algorithms used with those approaches are generally straightforward, they are complex because different pairs of antennas are used successively to break phase ambiguities. For example, in one approach, a very short baseline interferometer can be used to provide a coarse result, which narrows the range of possibilities. A somewhat larger baseline interferometer can be used to provide a more refined result, which further narrows the range of possibilities. This May continue during multiple iterations in order to achieve very high accuracy. Unfortunately, this approach requires a relatively large number of antennas, there are still spacing constraints placed on the antennas, and the time needed to calculate the iterative solution may be lengthy. While deep learning approaches might be used, they tend to be computationally expensive and slow, which can limit or prevent their usage in real-time applications.

This disclosure provides various techniques for direction-finding ambiguity resolution in long baseline interferometers using random forest regression. As described in more detail below, an interferometer includes multiple antennas. At least some of the antennas may be separated from one another by one or more distances such that one or more incoming signals received at one or more of the antennas experience phase wrapping relative to the one or more incoming signals received at one or more others of the antennas. Each antenna has an associated antenna response, which defines how phases (and possibly amplitudes) of electrical signals generated by the antenna can vary based on an angle of arrival of the one or more incoming signals. The electrical signals generated by each antenna can be used to generate phase measurements and optionally amplitude measurements, such as in the form of complex voltages. At least the phase measurements generated by the antennas are processed (possibly after pre-processing) using a random forest regressor. The random forest regressor generates multiple initial predictions of the angle of arrival of the one or more incoming signals based on at least the phase measurements, and the random forest regressor combines the initial predictions in order to generate a final prediction of the angle of arrival. The final prediction of the angle of arrival may be used for any suitable purpose, such as direction finding.

In this way, it is possible to more quickly and easily identify the angles of arrival of incoming signals while providing phase ambiguity resolution, meaning the described techniques can identify the angles of arrival even in the presence of phase wrapping. The described techniques can also be used with arbitrary antenna placements, which helps to reduce or avoid rigid constraints involving the placement and spacing of the antennas. Further, the described techniques need not involve the use of complex search algorithms, which can improve the speed of the angle of arrival determinations and support real-time direction finding. For instance, unlike some approaches, the described techniques do not require the use of large calibration tables for each antenna at multiple frequencies and polarization states, the generation of an error surface between measurements and every possible solution, and a search of the error surface to find a global minimum without the benefit of Newtonian or gradient descent. This can significantly speed up the identification of angles of arrival and reduce processing and memory requirements.

Note that the techniques described in this patent document may find use in various applications. For example, in the discussion below, it is often assumed that the techniques described in this patent document are used with an aircraft in order to identify the angles of arrival of incoming signals received at the aircraft. However, this use case is for illustration and explanation only. The techniques described in this patent document may be used in any other suitable manner. For instance, devices and systems that support 5G communications or use global navigation satellite system (GNSS) signals (such as global positioning system or GPS receivers) may use the described techniques to perform direction finding. As particular example use cases, the described techniques may be used to support digital beamforming, communications, signal intelligence, or electronic intelligence. In general, the techniques described in this disclosure may be used for determining angles of arrival by any suitable device(s) and in any suitable system(s), and the angles of arrival may be used for any suitable purpose(s).

FIG. 1 illustrates an example long baseline interferometer 100 supporting direction-finding ambiguity resolution using random forest regression according to this disclosure. As shown in FIG. 1, the long baseline interferometer 100 includes multiple antennas 102, where each antenna 102 is configured to receive one or more incoming signals. For example, each antenna 102 may be configured to receive one or more incoming RF signals or other incoming signals at any suitable frequency or frequencies. Each antenna 102 includes any suitable structure configured to receive incoming electromagnetic signals. In some embodiments, for instance, the antennas 102 may represent dipole antennas, spiral antennas, or other suitable antennas. As a particular example, the antennas 102 may be formed using an antenna array, where different antennas 102 are associated with different array sub-apertures. In this example, the long baseline interferometer 100 is shown as including four antennas 102, but the long baseline interferometer 100 may include two or more antennas 102 depending on the implementation. In some cases, such as for phased array antennas, the number of antennas 102 may be quite large.

Electrical signals generated by the antennas 102 based on one or more incoming signals are provided to respective analog front ends (AFEs) 104, each of which is configured to process the electrical signals and generate antenna measurements associated with the one or more incoming signals. For example, each analog front end 104 can perform sampling in order to generate samples of the electrical signals for further processing. In some embodiments, each analog front end 104 may generate complex voltages that represent the one or more incoming signals as in-phase (I) or real voltages and quadrature (Q) or imaginary voltages, where the real voltage of a complex voltage can be defined as real voltage=amplitude*cos(phase) and the imaginary voltage of a complex voltage can be defined as amplitude*sin(phase). In some cases, each analog front end 104 may include a direct digital sampler or a sampler that processes a down-converted signal, although any other suitable sampling mechanism may be used here.

Each analog front end 104 can also perform correlations in order to associate pulses within the one or more incoming signals with one another. For example, each analog front end 104 may convert the complex voltages into pulse descriptor words, which can assign attributes like amplitude, phase, and time of arrival to individual pulses in the one or more incoming signals. Since the same incoming signal can be received by multiple antennas 102 (shifted in time and phase and differing somewhat in amplitude from one another), the correlations here help to associate different pulses with the same signal source(s). This is often referred to as pulse deinterleaving. Once the pulses are associated with each other, each analog front end 104 can convert the amplitudes and phases of the pulses back into complex voltages. Note that using phase by itself may suffer from issues since the phase wraps every 360°, which can create numerical problems for subsequent processing, but using complex data can help to reduce or eliminate this issue.

Each antenna 102 is associated with an antenna response 106, which defines how the phases and amplitudes of the complex voltages representing the one or more received signals can vary based on angles of arrival of incoming signals. In other words, the complex voltages that are generated by each analog front end 104 can represent phase measurements and amplitude measurements that vary in accordance with the antenna response 106 of the associated antenna 102. For instance, each antenna response 106 may identify how the phase and amplitude associated with an incoming signal can vary depending on the azimuth and elevation of the (apparent) source of the incoming signal. If needed or desired, the phase and amplitude measurements (such as in the form of complex voltages) may undergo suitable pre-processing prior to further use, such as to filter the phase and amplitude measurements.

The antenna measurements represented by the complex voltages are provided to a random forest regression processing function 108, which analyzes at least some of the measurements in order to estimate an angle of arrival 110 of the one or more incoming signals based on the analyzed measurements. As described below, the random forest regression processing function 108 uses multiple decision trees to process the measurements and generate initial predictions of the angle of arrival 110, and the random forest regression processing function 108 can average or otherwise use the initial predictions of the angle of arrival 110 in order to identify a final prediction of the angle of arrival 110 (which can be output). Effectively, the random forest regression processing function 108 can be trained to implement one or more functional mappings between (i) antenna phase measurements or other measurements and (ii) angles of arrival 110, which may be expressed in any suitable manner (such as azimuth and elevation angles).

In some embodiments, the long baseline interferometer 100 may include n antennas 102 that generate at least phase measurements varying based on n antenna responses 106. In particular embodiments, n has a value of at least four, although lower values may be possible. For long antenna baselines (meaning the antennas 102 are separated so that phase wrapping occurs), the antenna responses 106 often have a high degree of structure due to the ambiguities in both azimuth and elevation. This complexity makes it difficult to use an ordinary shallow neural network to perform phase ambiguity resolution. For example, this complexity may necessitate the use of large neural networks, which can be slow and require large amounts of processing and memory resources. Even then, large neural networks can have large errors in angle of arrival estimates. The use of random forest regression here can capture and represent the two-dimensional functions associated with mappings of antenna responses 106 to angles of arrival 110 sufficiently in order to achieve useful precision for direction finding. Additional details of the random forest regression processing function 108 are provided below.

Although FIG. 1 illustrates one example of a long baseline interferometer 100 supporting direction-finding ambiguity resolution using random forest regression, various changes may be made to FIG. 1. For example, the long baseline interferometer 100 may include any suitable number of antennas 102 and any suitable number of associated antenna responses 106. In this example, there are four antennas 102 and four associated antenna responses 106, although this is for illustration and explanation only. Also, the antennas 102 may have any desired arrangement and need not be positioned or spaced to satisfy strict requirements. In some cases, the described approaches can support arbitrary antenna placements, which can greatly simplify installation and use.

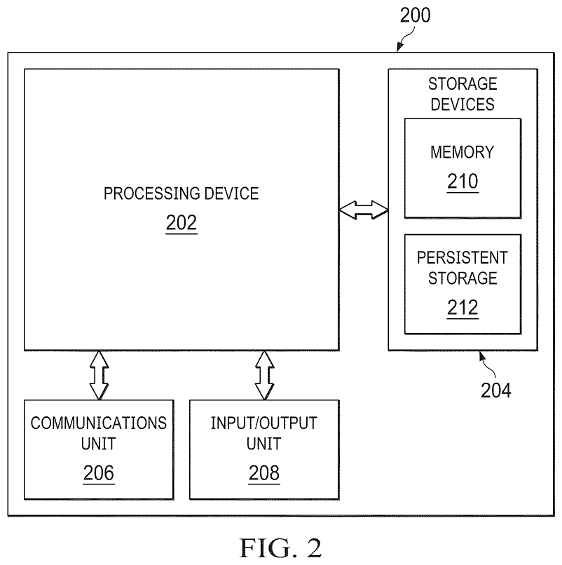

FIG. 2 illustrates an example device 200 supporting direction-finding ambiguity resolution in the long baseline interferometer 100 of FIG. 1 according to this disclosure. More specifically, FIG. 2 illustrates an example device 200 that may form part of or be used in conjunction with the long baseline interferometer 100. The device 200 here may be used to implement the random forest regression processing function 108 of the interferometer 100.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s). As a particular example, the communications unit 206 may support communication of estimated angles of arrival 110 to one or more external destinations for use. Note, however, that the processing device 202 itself may also or alternatively use the estimated angles of arrival 110, and the estimated angles of arrival 110 may or may not be communicated outside the device 200.

The I/O unit 208 allows for input and output of data. For example, the I/O unit 208 may be used to receive phase measurements, amplitude measurements, or other data from the antennas 102. The I/O unit 208 may also be used for other interactions. For instance, the I/O unit 208 may provide a connection for user input through a keyboard, mouse, keypad, touchscreen, or other suitable input device. The I/O unit 208 may also send output to a display or other suitable output device. Note, however, that these functions may be optional, such as when the device 200 or the interferometer 100 does not require local I/O (like when the device 200 or the interferometer 100 can be accessed remotely).

In some embodiments, the instructions executed by the processing device 202 include instructions that implement the random forest regression processing function 108. Thus, for example, the instructions when executed by the processing device 202 may cause the device 200 to obtain phase measurements and amplitude measurements, such as in the form of complex voltages (which may be pre-processed if needed or desired). The instructions when executed by the processing device 202 may also cause the device 200 to process the measurements using random forest regression and generate angles of arrival 110. The instructions when executed by the processing device 202 may optionally cause the device 200 to use the angles of arrival 110 to perform one or more functions, such as for direction finding or other purposes.

Although FIG. 2 illustrates one example of a device 200 supporting direction-finding ambiguity resolution in the long baseline interferometer 100 of FIG. 1, various changes may be made to FIG. 2. For example, computing and communication devices and systems come in a wide variety of configurations, and FIG. 2 does not limit this disclosure to any particular computing or communication device or system. The random forest regression processing function 108 of the long baseline interferometer 100 may be implemented in any other suitable manner. For instance, data collected by or using the antennas 102 and the analog front ends 104 may be post-processed offline or uploaded over a data link, such as to a cloud computing resource or other computing system. It is also possible for the logic of the random forest regression processing function 108 to be hosted in a containerized environment, in which case at least some of the hardware shown in FIG. 2 may be virtualized.

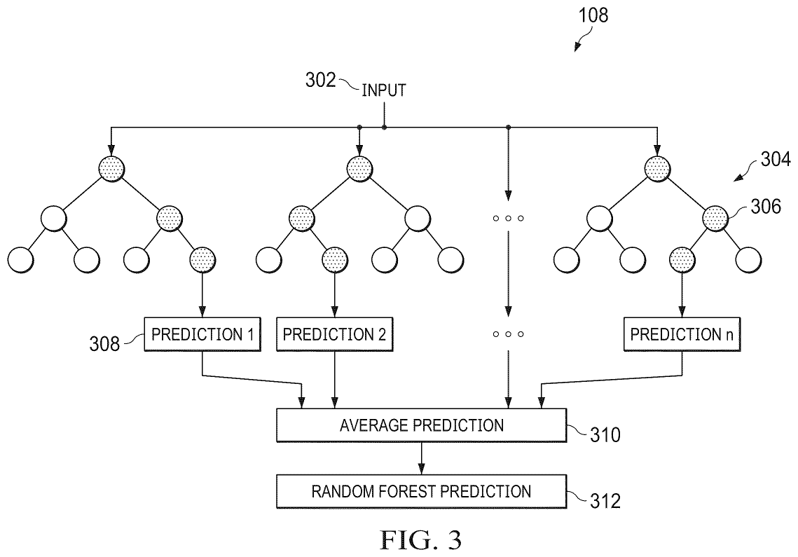

FIG. 3 illustrates an example random forest regression processing function 108 for direction-finding ambiguity resolution in the long baseline interferometer 100 of FIG. 1 according to this disclosure. As shown in FIG. 3, the random forest regression processing function 108 is configured to receive and process input data 302, which in this example may include phase measurements and optionally amplitude measurements and which can be associated with or based on the antenna responses 106. The random forest regression processing function 108 implements multiple decision trees 304, where each decision tree 304 includes a number of nodes 306 logically positioned in multiple layers or levels of the decision tree 304.

Each node 306 in a layer of a decision tree 304 can process at least some of the input data 302 and make determinations as to which node 306 in an adjacent lower layer of the decision tree 304 will be used to process the input data 302, except for the leaf nodes 306 (the bottom nodes 306 in the decision tree 304). When specific input data 302 is being processed by each decision tree 304, the input data 302 is processed using the sole node 306 in the top layer of that decision tree 304. This node 306 analyzes the input data 302 and selects one node 306 in the second layer of the decision tree 304 that will receive and process the input data 302. That node 306 analyzes the input data 302 and selects one node 306 in the third layer of the decision tree 304 that will receive and process the input data 302. This process may continue through the layers of the decision tree 304 until one of the leaf nodes 306 at the lowest layer of the decision tree 304 is reached. Note that each node 306 may process the same portion(s) of the input data 302 or different portions of the input data 302. The leaf node 306 generates an initial prediction 308 based on the input data 302. In the specific context here, each initial prediction 308 can represent an initial prediction of an angle of arrival 110 based on the antenna measurements being processed.

A combination function 310 combines the initial predictions 308 in order to generate a random forest prediction 312, which represents or includes a final prediction of the angle of arrival 110 based on the measurements being processed. The combination function 310 may use any suitable technique to combine the initial predictions 308 and generate the random forest prediction 312. In the illustrated example, the combination function 310 performs an averaging function, which can average the initial predictions 308. However, the combination function 310 may perform other calculations to generate the random forest prediction 312. Other example implementations of the combination function 310 may include majority voting (where the most common initial prediction 308 is used as the random forest prediction 312) or weighted averaging (where confidence levels or other values associated with the initial predictions 308 are used to weight the initial predictions 308 during the averaging).

Each decision tree 304 here represents a decision tree regressor or estimator used to predict an angle of arrival 110. One or more hyperparameters may be used to help define the structure or operation of each decision tree 304, such as when hyperparameters are used to define the minimum number of input samples at each leaf node 306 needed to make an initial prediction 308 or the maximum depth (number of layers of nodes 306) that each decision tree 304 may include.

The random forest regression processing function 108 may be trained in any suitable manner to generate angles of arrival 110. During training, the random forest regression processing function 108 can be modified so that the nodes 306 of the decision trees 304 process training data and collectively arrive at accurate estimates of the angles of arrival 110, at least to within some threshold level of accuracy. Among other things, this may involve adjusting the determinations made by the individual nodes 306 in each decision tree 304, adjusting the number of nodes 306 in each decision tree 304, and adjusting the number of layers in each decision tree 304.

In some embodiments, the random forest regression processing function 108 may undergo a training process in which its inputs and outputs are reversed. In these embodiments, the random forest regression processing function 108 can be provided training data that includes azimuth and elevation angles or other angles of arrival 110 of an emitter, and the random forest regression processing function 108 is trained to generate multiple phase measurements. The generated phase measurements represent phase measurements that the random forest regression processing function 108 expects to be received from the antennas 102 if incoming signals are received by the antennas 102 at the angles of arrival 110 included in the training data. These phase measurements can be compared to known ground truths, which represent correct phase measurements that the random forest regression processing function 108 should have generated based on the training data. When errors or differences between the phase measurements generated by the random forest regression processing function 108 and the ground truth phase measurements exceed a threshold, the decision trees 304 of the random forest regression processing function 108 can be adjusted in various ways, such as those noted above. Once adjusted, another round of training may occur in which the same or different angles of arrival 110 are provided to the adjusted decision trees 304 of the random forest regression processing function 108, and additional phase measurements are generated and compared to their ground truths so that additional errors can be calculated and compared to the threshold. This process may continue until (ideally) the random forest regression processing function 108 generates adequately-accurate phase measurements. At this point, the random forest regression processing function 108 may be used to provide mappings between phase measurements actually generated by the antennas 102 and angles of arrival 110. In particular embodiments, the phase measurements can take the form of voltages, and the random forest regression processing function 108 can be trained and used to directly map those voltages into angles of arrival 110. This type of approach eliminates the generation and searching of an error surface, which is typically slow and requires more processing and memory resources.

Through suitable training of the random forest regression processing function 108, the random forest regression processing function 108 can be trained to effectively identify angles of arrival 110 for incoming signals. The random forest regression processing function 108 can be effective even in the presence of noise, such as when poor signal-to-noise ratios are present or there is random phase noise in the antenna measurements being processed. The accuracy of the random forest regression processing function 108 can be based, at least in part, on the number of decision trees 304 used in the random forest regression processing function 108.

Although FIG. 3 illustrates one example of a random forest regression processing function 108 for direction-finding ambiguity resolution in the long baseline interferometer 100 of FIG. 1, various changes may be made to FIG. 3. For example, the random forest regression processing function 108 may include any suitable number of decision trees 304. Also, each decision tree 304 may include any suitable number of nodes 306, and the nodes 306 of each decision tree 304 may be arranged in any suitable number of layers. Because the decision trees 304 can operate in parallel, the number of decision trees 304 and the sizes of the decision trees 304 may be limited by available resources, such as processing or memory resources.

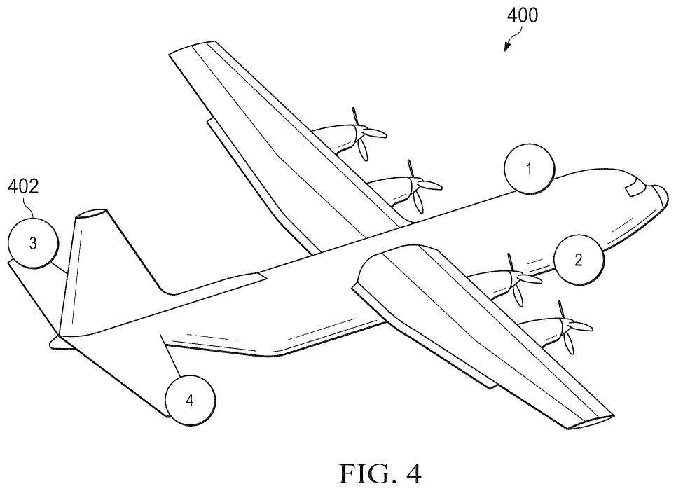

FIGS. 4 through 6 illustrate an example use case for applying direction-finding ambiguity resolution in a long baseline interferometer 100 according to this disclosure. As shown in FIG. 4, one example of a system 400 in which a long baseline interferometer 100 may be used represents an aircraft. Various positions 402 on the aircraft identified in FIG. 4 represent locations where the antennas 102 may be positioned. Note that the number of positions 402 and the locations of the positions 402 on the aircraft can vary as needed or desired. In this particular example, the positions 402 include two positions (labeled “1” and “2”) near the nose of the aircraft that are positioned on opposite sides of a longitudinal axis of the aircraft, as well as two positions (labeled “3” and “4”) on the tail of the aircraft that are positioned on opposite sides of the longitudinal axis of the aircraft. However, these positions 402 are for illustration and explanation only. As described above, these positions 402 can be separated by adequate distances such that phase wrapping can occur for at least some of the antennas 102. Also, as noted above, there may not be strict position and spacing requirements when identifying the positions 402.

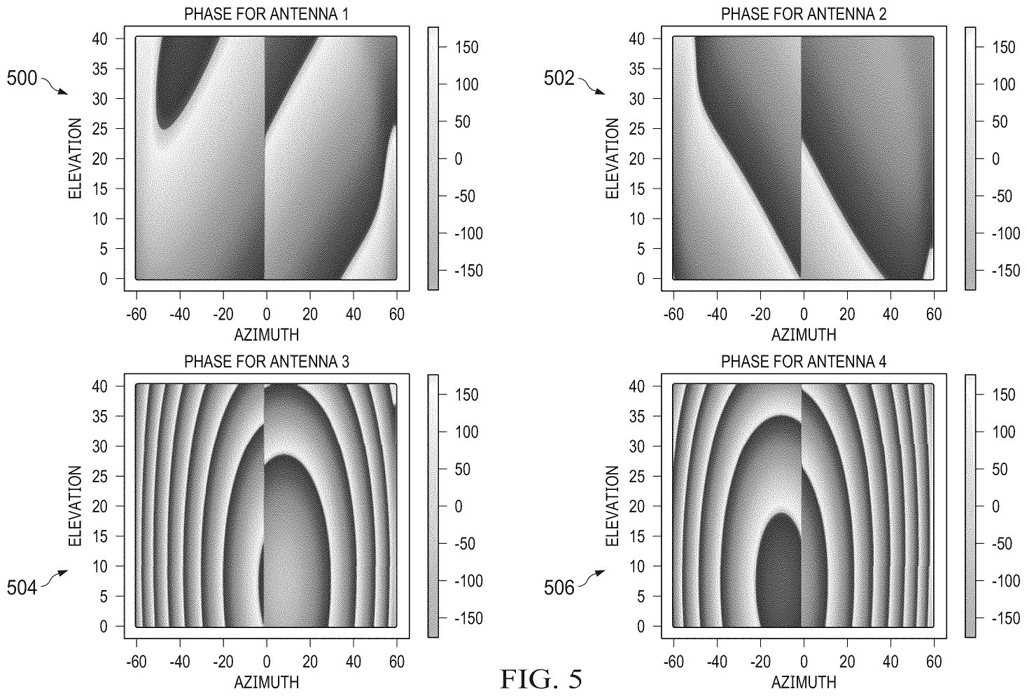

Example phase responses for the antennas 102 in these positions 402 are shown in various charts 500-506 in FIG. 5. More specifically, the charts 500-506 illustrate phase responses of the antennas 102 relative to a phase center associated with a midpoint or center of the aircraft for a 1 GHz incoming signal. The phase response of each antenna 102 varies here based on the angle of arrival for the incoming signal, where each chart 500-506 identifies the phase response of the associated antenna 102 as a function of azimuth (along the horizontal axis) and elevation (along the vertical axis). As can be seen here, the phase responses of the antennas 102 are significantly different even for the same incoming signal. These differences can make it extremely difficult if not impossible to use a single shallow neural network to analyze antenna measurements and identify angles of arrival 110.

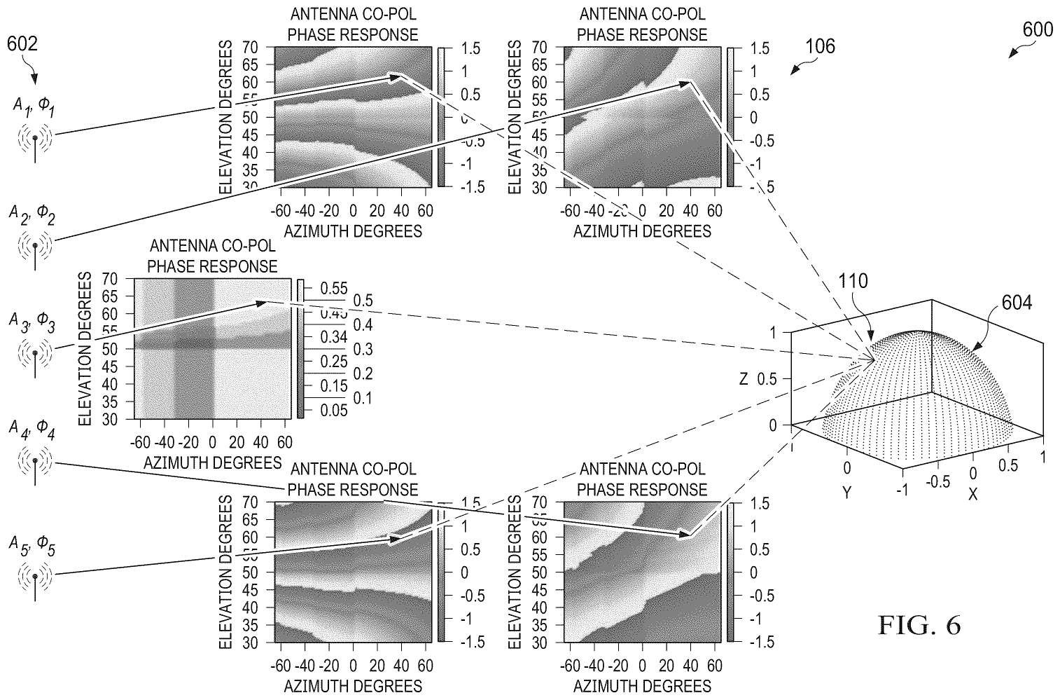

Instead, a process 600 as shown in FIG. 6 can be used. In this process 600, input data 602 includes amplitude measurements (denoted A₁-A₅) and phase measurements (denoted ϕ₁-ϕ₅) obtained using a number of antennas 102. The input data 602 may, for example, represent the input data 302 described above with respect to FIG. 3. These amplitude and phase measurements are based on the antenna responses 106 of the antennas 102, meaning the amplitude and phase measurements are associated with at least one incoming signal and vary based on the angle of arrival of the incoming signal(s). The amplitude and phase measurements are provided to the random forest regression processing function 108, which processes the measurements in order to generate a final estimate of the angle of arrival 110 of the incoming signal(s). Here, the angle of arrival 110 is represented as a point on a hemisphere 604, although this is for ease of illustration only and does not limit the angle of arrival 110 to any specific range of values.

One example benefit of using random forest regression here is that different decision trees 304 may be trained to more effectively identify angles of arrival 110 for different spaces around the long baseline interferometer 100. For example, the hemisphere 604 or other space may be divided into quadrants, and different decision trees 304 may be more effective at identifying angles of arrival 110 in different ones of the quadrants.

Although FIGS. 4 through 6 illustrate one example use case for applying direction-finding ambiguity resolution in a long baseline interferometer 100, various changes may be made to FIGS. 4 through 6. For example, the long baseline interferometer 100 may be used on any other suitable platform or in any other suitable device or system. Also, the phase responses shown in FIG. 5 and the antenna responses shown in FIG. 6 are for illustration and explanation only and can easily vary depending on the installation and design of the antennas 102 being employed. In addition, the number of antennas 102 used can vary depending on the implementation.

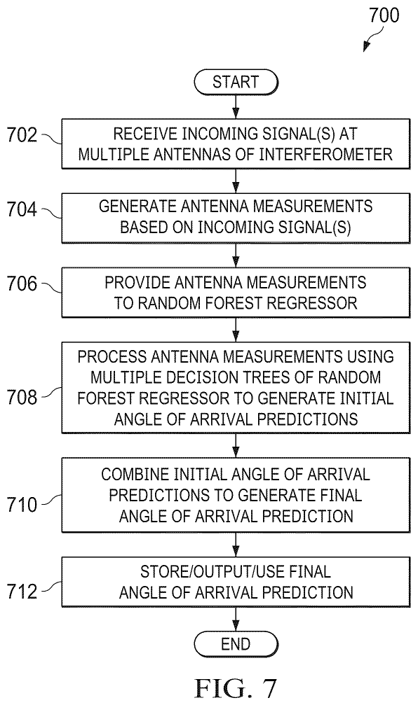

FIG. 7 illustrates an example method 700 for direction-finding ambiguity resolution in a long baseline interferometer using random forest regression according to this disclosure. For ease of explanation, the method 700 is described as being performed using the long baseline interferometer 100 of FIG. 1, which may include or be used in conjunction with the device 200 of FIG. 2. However, the method 700 may be used with any suitable device(s) and in any suitable system(s).

As shown in FIG. 7, one or more incoming signals are received at multiple antennas of an interferometer at step 702. This may include, for example, receiving one or more incoming signals from a signal source at multiple antennas 102 of the interferometer 100, such as from an airplane, ground vehicle, naval vessel, or other signal source on the ground, in the air, on the water, or in space. In some cases, at least some of the antennas 102 of the interferometer 100 may be separated from one another by one or more distances such that the one or more incoming signals received at one or more of the antennas 102 experience phase wrapping relative to the one or more incoming signals received at one or more others of the antennas 102. Antenna measurements based on the one or more incoming signals are generated at step 704. This may include, for example, sampling electrical signals from the antennas 102 in order to generate complex voltages, correlating related pulses from one or more common signal sources, and converting pulse descriptor words back into complex voltages. The complex voltages can include or represent phase measurements and amplitude measurements associated with the one or more incoming signals. In some cases, the antenna measurements may undergo pre-processing, such as to filter the antenna measurements.

The antenna measurements are provided to a random forest regressor at step 706, and the antenna measurements are processed using multiple decision trees of the random forest regressor to generate initial angle of arrival predictions at step 708. This may include, for example, each of the decision trees 304 in the random forest regression processing function 108 processing at least some of the phase measurements (and optionally at least some of the amplitude measurements) in order to generate initial predictions 308 of an angle of arrival of the one or more incoming signals. The initial angle of arrival predictions are combined to generate a final angle of arrival prediction at step 710. This may include, for example, the combination function 310 combining the initial predictions 308 (such as via averaging, weighted averaging, majority voting, or other technique) to generate a random forest prediction 312, which represents a final prediction of the angle of arrival 110.

The final angle of arrival prediction is stored, output, or used in some manner at step 712. This may include, for example, the interferometer 100 or an external component using the angle of arrival to perform direction finding in order to identify an estimated direction to the source of the incoming signal(s). The exact use of the angle of arrival can vary depending on the application or use case.

Although FIG. 7 illustrates one example of a method 700 for direction-finding ambiguity resolution in a long baseline interferometer using random forest regression, various changes may be made to FIG. 7. For example, while shown as a series of steps, various steps in FIG. 7 may overlap, occur in parallel, occur in a different order, or occur any number of times. As a particular example, the various steps of the method 700 can be repeatedly performed in order to identify the angles of arrival of the same incoming signal(s) or different incoming signals over time. Because of the features of the long baseline interferometer 100 described above, the angles of arrival may be determined in real-time in some embodiments.

It should be noted that the functions shown in or described with respect to FIGS. 1 through 7 can be implemented in an interferometer or other device(s) in any suitable manner. For example, in some embodiments, at least some of the functions shown in or described with respect to FIGS. 1 through 7 can be implemented or supported using software instructions that are executed by the processing device(s) 202 of the interferometer or other device(s). In other embodiments, at least some of the functions shown in or described with respect to FIGS. 1 through 7 can be implemented or supported using dedicated hardware components. In general, the functions shown in or described with respect to FIGS. 1 through 7 can be performed using any suitable hardware or any suitable combination of hardware and software/firmware instructions. Also, the functions shown in or described with respect to FIGS. 1 through 7 can be performed by a single device or by multiple devices.

The following describes example embodiments of this disclosure that implement or relate to direction-finding ambiguity resolution in long baseline interferometers using random forest regression. However, other embodiments may be used in accordance with the teachings of this disclosure.

In a first embodiment, an apparatus includes multiple antennas each configured to receive one or more incoming signals. The apparatus also includes at least one processing device configured to receive antenna measurements associated with the one or more incoming signals, where the antenna measurements include phase measurements associated with the one or more incoming signals. The at least one processing device is also configured to process the antenna measurements using multiple decision trees of a random forest regressor, where the decision trees are configured to generate multiple initial predictions of an angle of arrival associated with the one or more incoming signals. In addition, the at least one processing device is configured to combine the initial predictions in order to generate a final prediction of the angle of arrival associated with the one or more incoming signals.

In a second embodiment, a method includes receiving one or more incoming signals at multiple antennas. The method also includes providing antenna measurements associated with the one or more incoming signals to a random forest regressor, where the antenna measurements include phase measurements associated with the one or more incoming signals. The method further includes processing the antenna measurements using multiple decision trees of the random forest regressor, where the decision trees generate multiple initial predictions of an angle of arrival associated with the one or more incoming signals. In addition, the method includes combining the initial predictions in order to generate a final prediction of the angle of arrival associated with the one or more incoming signals.

In a third embodiment, a non-transitory machine-readable medium contains instructions that when executed cause at least one processor to obtain antenna measurements associated with one or more incoming signals received at multiple antennas, where the antenna measurements include phase measurements associated with the one or more incoming signals. The non-transitory machine-readable medium also contains instructions that when executed cause the at least one processor to provide the antenna measurements to a random forest regressor and process the antenna measurements using multiple decision trees of the random forest regressor, where the decision trees are configured to generate multiple initial predictions of an angle of arrival associated with the one or more incoming signals. In addition, the non-transitory machine-readable medium contains instructions that when executed cause the at least one processor to combine the initial predictions in order to generate a final prediction of the angle of arrival associated with the one or more incoming signals.

Any single one or any suitable combination of the following features may be used with the first, second, or third embodiment. The random forest regressor may be configured to implement one or more mappings between different antenna measurements and different angles of arrival. At least some of the antennas may be separated from one another by one or more distances such that the one or more incoming signals received at one or more of the antennas experience phase wrapping relative to the one or more incoming signals received at one or more others of the antennas. The phase measurements may be based on antenna responses of the multiple antennas, and each of the antennas may have a different antenna response than one or more others of the antennas. The initial predictions may be averaged in order to generate the final prediction of the angle of arrival. The antennas may have arbitrary positions on a platform. Final predictions of the angle of arrival associated with the one or more incoming signals may be repeatedly identified in real-time.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
multiple antennas each configured to receive one or more incoming signals; and
at least one processing device configured to:
receive antenna measurements associated with the one or more incoming signals, the antenna measurements comprising phase measurements associated with the one or more incoming signals;
process the antenna measurements using multiple decision trees of a random forest regressor, the decision trees configured to generate multiple initial predictions of an angle of arrival associated with the one or more incoming signals; and
combine the initial predictions in order to generate a final prediction of the angle of arrival associated with the one or more incoming signals.

2. The apparatus of claim 1, wherein the random forest regressor is configured to implement one or more mappings between different antenna measurements and different angles of arrival.

3. The apparatus of claim 1, wherein at least some of the antennas are separated from one another by one or more distances such that the one or more incoming signals received at one or more of the antennas experience phase wrapping relative to the one or more incoming signals received at one or more others of the antennas.

4. The apparatus of claim 1, wherein the phase measurements are based on antenna responses of the multiple antennas, each of the antennas having a different antenna response than one or more others of the antennas.

5. The apparatus of claim 1, wherein, to combine the initial predictions in order to generate the final prediction of the angle of arrival, the at least one processing device is configured to average the initial predictions.

6. The apparatus of claim 1, wherein the antennas have arbitrary positions on a

7. The apparatus of claim 1, wherein the at least one processing device is configured to repeatedly identify final predictions of the angle of arrival associated with the one or more incoming signals in real-time.

8. A method comprising:
receiving one or more incoming signals at multiple antennas;
providing antenna measurements associated with the one or more incoming signals to a random forest regressor, the antenna measurements comprising phase measurements associated with the one or more incoming signals;
processing the antenna measurements using multiple decision trees of the random forest regressor, the decision trees generating multiple initial predictions of an angle of arrival associated with the one or more incoming signals; and
combining the initial predictions in order to generate a final prediction of the angle of arrival associated with the one or more incoming signals.

9. The method of claim 8, wherein the random forest regressor implements one or more mappings between different antenna measurements and different angles of arrival.

10. The method of claim 8, wherein at least some of the antennas are separated from one another by one or more distances such that the one or more incoming signals received at one or more of the antennas experience phase wrapping relative to the one or more incoming signals received at one or more others of the antennas.

11. The method of claim 8, wherein the phase measurements are based on antenna responses of the multiple antennas, each of the antennas having a different antenna response than one or more others of the antennas.

12. The method of claim 8, wherein combining the initial predictions in order to generate the final prediction of the angle of arrival comprises averaging the initial predictions.

13. The method of claim 8, wherein the antennas have arbitrary positions on a

14. The method of claim 8, further comprising:
repeatedly identifying final predictions of the angle of arrival associated with the one or more incoming signals in real-time.

15. A non-transitory machine-readable medium containing instructions that when executed cause at least one processor to:
obtain antenna measurements associated with one or more incoming signals received at multiple antennas, the antenna measurements comprising phase measurements associated with the one or more incoming signals;
provide the antenna measurements to a random forest regressor;
process the antenna measurements using multiple decision trees of the random forest regressor, the decision trees configured to generate multiple initial predictions of an angle of arrival associated with the one or more incoming signals; and
combine the initial predictions in order to generate a final prediction of the angle of arrival associated with the one or more incoming signals.

16. The non-transitory machine-readable medium of claim 15, wherein the random forest regressor is configured to implement one or more mappings between different antenna measurements and different angles of arrival.

17. The non-transitory machine-readable medium of claim 15, wherein at least some of the antennas are separated from one another by one or more distances such that the one or more incoming signals received at one or more of the antennas experience phase wrapping relative to the one or more incoming signals received at one or more others of the antennas.

18. The non-transitory machine-readable medium of claim 15, wherein the phase measurements are based on antenna responses of the multiple antennas, each of the antennas having a different antenna response than one or more others of the antennas.

19. The non-transitory machine-readable medium of claim 15, wherein the instructions that when executed cause the at least one processor to combine the initial predictions in order to generate the final prediction of the angle of arrival comprise:
instructions that when executed cause the at least one processor to average the initial predictions.

20. The non-transitory machine-readable medium of claim 15, further containing instructions that when executed cause the at least one processor to repeatedly identify final predictions of the angle of arrival associated with the one or more incoming signals in real-time.
